(19) United States
(12) Patent Application Publication
(10) Pub. No.: US 2014/0064717 A1
(43) Pub. Date: Mar. 6, 2014

(54) CABLE WITH SOFT CORE FOR DIRECT ELECTRICAL HEATING OF SUBSEA PIPELINE

(71) Applicants: Atle Harald Børnes, Fyllingsdalen (NO); Anna Timoshenko, Stavanger (NO); Even Tjåland, Bryne (NO); Geir Endal, Levanger (NO)

(72) Inventors: Atle Harald Børnes, Fyllingsdalen (NO); Anna Timoshenko, Stavanger (NO); Even Tjåland, Bryne (NO); Geir Endal, Levanger (NO)

(73) Assignee: STATOIL PETROLEUM AS, Stavanger (NO)

(21) Appl. No.: 13/977,373

(22) PCT Filed: Dec. 29, 2010
(86) PCT No.: PCT/EP10/70863

§ 371 Date: Nov. 14, 2013

(51) Int. Cl. H05B 3/56; F16L 53/00

(52) U.S. Cl. CPC H05B 3/56; F16L 53/008
USPC 392/480; 219/549

(57) ABSTRACT

A cable for direct electrical heating of a subsea pipeline includes an axially soft inner core; and electrically conducting wires surrounding said core. A system includes such a cable, use of such a cable, and a method for direct electrical heating of a subsea oil/gas pipeline.

The present invention relates to a cable for direct electrical heating (DEH) of a subsea pipeline. The present invention also relates to a system comprising such a cable, use of such a cable, and a method for direct electrical heating of a subsea oil/gas pipeline.

Direct electrical heating (DEH) is a method for preventing wax and hydrates to form in subsea production pipelines of oil and gas. DEH is based on the fact that an electric alternating current (AC) in a metallic conductor generates heat in a single phase circuit. One cable is connected to the first end of the pipeline and a single core cable is piggybacked on the pipeline and connected to the far end of the pipeline. The two cables together with the pipeline form a single phase electrical circuit. The piggyback cable is either strapped directly to the pipeline or located inside an external mechanical protection which is strapped to the pipeline.

A traditional DEH piggyback cable is a single core high voltage cable. The conductor is made of round stranded compacted copper wires, the insulation system is made of cross-linked polyethylene (XLPE), while the outer sheath is made of extruded polyethylene (PE).

A problem with the traditional DEH piggyback cable is that the copper wires are strained to an unacceptable level during operation of the pipeline unless complex and costly mitigating measures are carefully performed during installation. Thermal expansion of the pipeline will occur due to high production flow temperatures. The piggyback cable is equally strained, as it is connected and strapped to the pipeline. Furthermore, the piggyback cable may be additionally strained at pipeline thermal buckling locations (lateral or upheaval buckling). The elongation of the piggyback cable is typically more than 0.2% due to the above effects. Maximum allowable tensile strain for a single core piggyback cable is typically 0.15%. The limiting element in the cable design with regards to axial strain is the copper conductor. Axial strain beyond allowable level may lead to plastic deformation of the copper wires which should be avoided. In order not to exceed maximum allowable cable strain, the piggyback cable is normally installed with some over length relative to the pipeline. If the cable is installed inside an external mechanical protection with an inner diameter significant larger than the outer diameter of the cable, over length of the cable may be achieved by keeping the back tension of the cable low (the weight of the cable will then cause the cable to snake inside the protection thereby introducing over length). This is a complex operation from an installation point of view as the back tension of the cable is difficult to control. For the case when the cable is strapped directly to the pipeline, cable over length is very difficult to achieve from an installation/practical point of view. It is also very difficult to measure achieved over length with traditional measuring instruments as they have more inaccuracy than needed cable over length (app. 0.1%).

US2004108125 (Thomassen) discloses an electrical cable system and a method for manufacturing an electrical cable system comprising an electrical cable containing a conductor core and for installing said electrical cable system over a longitudinally expandable-contractible element. The method comprises the successive steps of: disposing a secondary element over said electrical cable so as to give said electrical cable substantially attached undulations thereby forming an additional length, installing by clamping at least at two points said electrical cable system to said longitudinally expandable-contractible element, handling said secondary element after said clamping so as to release the attachment of said undulations thereby converting said additional length into a free to be used excess length. The excess length produced after clamping supposedly allows said electrical cable to cope with the length fluctuations of said extractable-contractible element without increasing the tension.

However, the solution in US2004108125 is based on a traditional electrical cable. Further, the solution for coping with the length fluctuations requires additional steps than just clamping the cable to the longitudinally expandable-contractible element, making it unduly complicated and costly.

It is an object of the present invention to at least partly overcome the above problems, and to provide an improved cable for direct electrical heating of a subsea pipeline. A particular object is to provide a cable which can withstand the actual strain required for the DEH piggyback application.

These objects, and other objects that will become apparent from the following description, are achieved by a cable, system, use, and method according to the appended independent claims. Embodiments are set forth in the dependent claims.

According to an aspect of the present invention, there is provided a cable for direct electrical heating of a subsea pipeline, the cable comprising: an axially soft inner core; and electrically conducting wires surrounding said core.

The inner core may be made of axially soft material. The axially soft material may have a low elastic modulus. The axially soft material may for instance have an elastic modulus of less than 10 kN/mm² (GPa), wherein all possible range combinations will be more or less appropriate, suitable, or desirable.

Further, the electrically conducting wires may be helically stranded around the core at a lay angle defined relative to the center longitudinal axis of the cable. The lay angle may be selected according to a specific allowable maximum axial strain of the cable. The lay angle may for instance be between 25° and 55°.

The present invention reduces the axial stiffness of the cable, by introducing a design where an inner core can be made of an axially soft material, and in addition the lay angle of the outer electrically conducting wires may be optimized (increased). This design will ensure that the strains in the cable during operation of the pipeline are acceptable without performing complex and costly mitigating measures during installation. From an electrical point of view, it will have a small impact as the innermost portion of the cable is hardly used for conducting currents due to the skin effect. From a mechanical point of view, replacing the inner copper wire(s) of a traditional DEH piggyback cable with a soft material will make the whole cable softer and reduce the axial stiffness of the cable allowing more strain before the outer electrically conducting wires (typically copper) are plastic deformed. Further, with the present invention it will not be necessary to install the cable with over length relative to the pipeline. This will make the installation process much easier and it will remove the uncertainty whether or not the cable was installed with sufficient over length. This will also lead to increased safety of the overall DEH system, as the need for cable over length is eliminated. Further, the cable weight may be smaller as the inner copper wire(s) is/are replaced by the axially soft material that typically is lighter than copper. Handling of the cable will thus be much easier during fabrication, transport and installation. Also, the cost for the cable will be reduced as a major part of the cost for a DEH piggyback cable is related to purchase of copper.

According to another aspect of the present invention, there is provided a system for direct electrical heating of a subsea pipeline, the system comprising: a cable according to the above description; and an electrical power supply with a two-conductor supply cable or two single conductor supply cables, wherein the cable is provided along at least a portion of the pipeline and electrically connected to the pipeline and to one conductor of the supply cable(s), and wherein the other conductor of the supply cable(s) is electrically connected to the pipeline, to form an electrical circuit . This aspect may exhibit the same or similar features and technical effects as the previously described aspect of the invention.

Yet another aspect of the present invention relates to the use of a cable according to the above description as a piggyback cable for direct electrical heating of a subsea oil/gas pipeline. This aspect may exhibit the same or similar features and technical effects as the previously described aspects of the invention.

According to still another aspect of the present invention, there is provided a method for direct electrical heating of a subsea oil/gas pipeline, which method comprises: providing a cable according to any the above description along at least a portion to said pipeline; and supplying electric current in a circuit formed by or including said cable and the pipeline. This aspect may exhibit the same or similar features and technical effects as the previously described aspects of the invention.

These and other aspects of the present invention will now be described in more detail, with reference to the appended drawings showing a currently preferred embodiment of the invention.

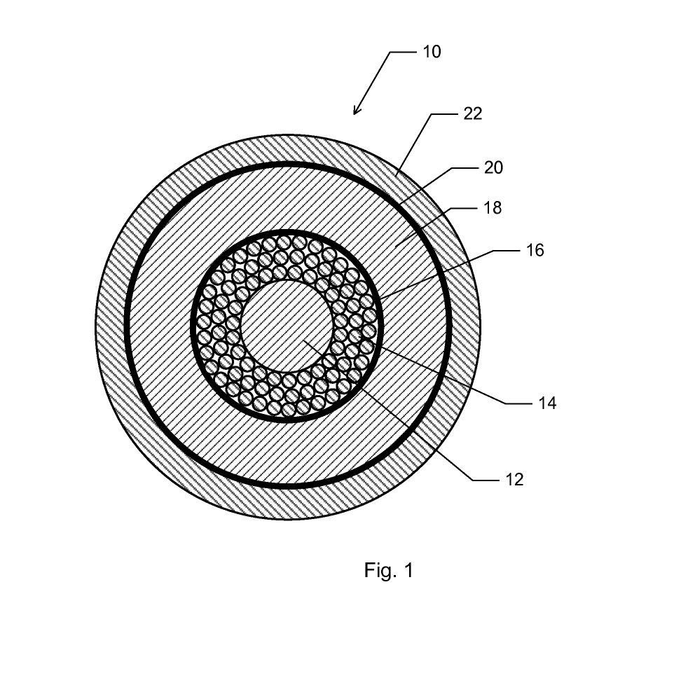

FIG. 1 shows a cross-section of a cable according to an embodiment of the present invention.

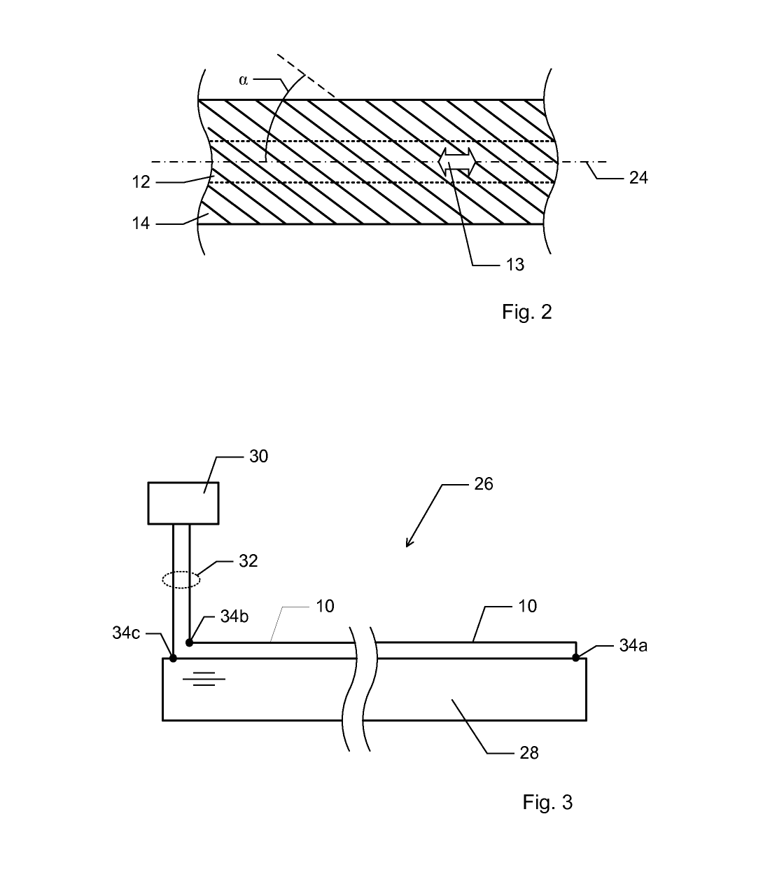

FIG. 2 is a partial lengthwise section view of the cable in FIG. 1.

FIG. 3 is a schematic side view of a system for direct electrical heating of a subsea pipeline according to the present invention.

A cable 10 for direct electrical heating of a subsea pipeline according to an embodiment of the present invention is shown in FIGS. 1 and 2. The cable 10 comprises an inner(most), central core 12, as seen from the cross-sectional view. The inner core 12 may extend the full length of the cable 10. The inner core 12 is axially soft. That is, the inner core 12 is soft in the axial or longitudinal direction of the cable 10, so that it may be extended or contracted in the axial or longitudinal direction of the cable 10 as indicated by the double arrow 13 in FIG. 2. The inner core 12 is for instance made of axially soft material. The axially soft material of the inner core 12 preferably has a low elastic modulus (modulus of elasticity/E-modulus). The axially soft material of the inner core 12 may for instance have an elastic modulus of less than 10 kN/mm²(=10 GPa (Gigapascal)), wherein all possible range combinations for elastic modulus of less than 10 GPa will be more or less appropriate, suitable, or desirable. In contrast, copper has an elastic modulus of about 130 GPa. The inner core 12 in the present cable 10 may for instance be made of PE (polyethylene) with elastic modulus 0.1-1.5 GPa (at room temperature), or of PP (polypropylene) with elastic modulus 1.2-2 GPa (at room temperature), though other suitable materials may be used as well. Further, the inner core 12 may be electrically conducting or electrically non-conducting. If the inner core 12 is electrically conducting, less copper cross-section is required. Also, the axially soft material core 12 may consist of several soft elements wound together. Also, the inner core 12 may be made of a uniform material which is inherently soft in at least one dimension (like e.g. polyethylene), or by a material that not necessarily is soft or soft enough in itself but that is structured or arranged so as to overall become axially soft. In the latter case, all layers (including the inner core 12) may be helically shaped, thus giving a softer cable design. This design can be without a straight central wire.

The cable 10 further comprises electrically conducting wires 14 surrounding the inner core 12. The electrically conducting wires 14 are preferably made of copper. The electrically conducting wires 14 are helically stranded around the core 12 at a lay angle α defined relative to the center longitudinal axis 24 of the cable 10, as seen in FIG. 2. A change in the lay angle of the wires 14 implies changes in axial strain of the wires. In general, a greater lay angle results in smaller axial strain in the wires. With a total cable axial strain of 0.15%, the axial strain of the wires 14 at a lay angle of 25 degree is 0.12%, at 35 degree it is 0.1%, at 45 degree it is 0.08%, and at 55 degree it is 0.05%. By for example implementing a lay angle a of 55 degree, the total cable strain can thus be 0.25% and still be in the elastic area of copper as the wires 14 made of copper in all layers will be limited to 0.15% of strain. Hence, the lay angle a of the wires 14 in the cable 10 may be selected according to a specific allowable maximum axial strain (e.g. 0.15%) of the cable 10. Also, the axial tension force for the cable 10 to cause the same elongation will be lower with increasing lay angle α. Reducing the axial tension force is advantageous for cable joints, as they are vulnerable to mechanical stress. The final design of the cable 10 may thus depend on several factors, such as installation depth (recovery and repair situations), pipeline production flow temperature (pipeline expansion), trenching of pipeline (no buckling), etc.

The cable 10 may further comprise, from the electrically conducting wires 14 and outwards, a conductor screen 16, insulation 18, an insulation screen 20, and an outer sheath 22, as illustrated in FIG. 1.

FIG. 3 illustrates a system 26 wherein the present cable 10 is piggybacked to a subsea pipeline 28 for direct electrical heating of the latter. The cable 10 may hence be denoted a ‘direct electrical heating piggyback cable’.

The pipeline 28 is for conveying hydrocarbons like oil and/or (natural) gas. It is typically installed or laid on the sea floor. Also, the pipeline 28 is typically made of steel, hence it is electrically conductive.

The system 26 further comprises an electrical power supply 30. The electrical power 30 supply may be provided topside. From the electrical power supply 30, there is a two-conductor supply cable 32 (or two single-conductor supply cables) extending down to the cable 10 and the pipeline 28 and connected thereto as will be explained next.

One end of the cable 10 is electrically connected to one end of the pipeline 28 at point 34a. The other end of the cable 10 is connected at point 34b near the other end of the pipeline 28 to one conductor of the supply cable 32. Between the points 34a and 34b, the cable 10 is piggybacked to the pipeline 28. The cable 10 may be provided along substantially the full length of the pipeline 28 as in FIG. 3, or alternatively along only a portion of the pipeline. Further, the cable 10 is either strapped directly to the pipeline 28 or located inside an external mechanical protection (not shown) which is strapped to the pipeline. At point 34c also near the other end of the pipeline 28, the other conductor of the supply cable 32 is electrically connected to the pipeline 28. Hence, the piggyback cable 10 and the supply cable 32 two cables together with the pipeline 28 form an electrical circuit.

Upon operation, alternating current is supplied from the power supply 32 and heat is generated in the pipeline (and also in the cable), which heat may prevent wax and hydrates to forming inside the pipeline 28. If the pipeline 28 expands, for instance when hot oil is transported through it, the present cable 10 will not be damaged even though the cable is strapped to the pipeline 28 without any over length and hence will be forced to expand along with the pipeline. This is due to the inventive design and construction of the present cable, as discussed above.

The person skilled in the art will realize that the present invention by no means is limited to the embodiment(s) described above. On the contrary, many modifications and variations are possible within the scope of the appended claims.

1.-13. (canceled)

14. A system for direct electrical heating of a subsea pipeline, the system comprising:
a cable having an axially soft inner core and electrically conducting wires surrounding said core, and
an electrical power supply with a two-conductor supply cable or two single conductor supply cables,
wherein the cable is provided along at least a portion of the pipeline and electrically connected to the pipeline and to one conductor of the supply cable(s), and wherein the other conductor of the supply cable(s) is electrically connected to the pipeline, to form an electrical circuit.

15. A system according to claim 14, wherein the inner core of the cable is made of axially soft material.

16. A system according to claim 15, wherein the axially soft material has a low elastic modulus.

17. A system according to claim 15, wherein the axially soft material has an elastic modulus of less than 10 kN/mm².

18. A system according to claim 14, wherein the electrically conducting wires of the cable are helically stranded around the core at a lay angle defined relative to the center longitudinal axis of the cable.

19. A system according to claim 18, wherein the lay angle is selected according to a specific allowable maximum axial strain of the cable.

20. A system according to claim 18, wherein the lay angle is between 25° and 55°.

21. A system according to claim 14, wherein the cable is piggybacked to the subsea pipeline.

22. A system according to claim 14, wherein the cable further comprises a conductor screen, insulation, an insulation screen, and an outer sheath.

23. A system according to claim 14, wherein the electrical power supply is adapted to supply alternating current.

24. A method for direct electrical heating of a subsea oil/gas pipeline, which method comprises:
providing a cable along at least a portion to said pipeline, wherein the cable has an axially soft inner core and electrically conducting wires surrounding said core; and
supplying alternating current in a circuit formed by or including said cable and the pipeline.

25. A subsea direct electrical heating piggyback cable, the cable comprising an axially soft inner core and electrically conducting wires surrounding said core.

26. A method comprising the step of using the cable according to claim 25 as a piggyback cable for direct electrical heating of a subsea oil/gas pipeline.

27. A system according to claim 16, wherein the axially soft material has an elastic modulus of less than 10 kN/mm².

28. A system according to claim 15, wherein the electrically conducting wires of the cable are helically stranded around the core at a lay angle defined relative to the center longitudinal axis of the cable.

29. A system according to claim 16, wherein the electrically conducting wires of the cable are helically stranded around the core at a lay angle defined relative to the center longitudinal axis of the cable.

30. A system according to claim 17, wherein the electrically conducting wires of the cable are helically stranded around the core at a lay angle defined relative to the center longitudinal axis of the cable.

31. A system according to claim 19, wherein the lay angle is between 25° and 55°.
